(19) United States
(12) Patent Application Publication
(10) Pub. No.: US 2011/0317229 A1
(43) Pub. Date: Dec. 29, 2011

(54) SCANNING DEVICE

(75) Inventors: Chien-Hsing Tang, Suzhou (CN); Kun-Yee Yang, Suzhou (CN); Ming-Jie Zhao, Suzhou (CN); Yun-Bin Gu, Suzhou (CN); Jian Shen, Suzhou (CN)

(73) Assignee: QISDA (SUZHOU) CO.,LTD, Suzhou (CN)

(21) Appl. No.: 13/162,539

(22) Filed: Jun. 16, 2011

(30) Foreign Application Priority Data
Jun. 24, 2010 (CN) 201010220628.4

(51) Int. Cl. H04N 1/04

(52) U.S. Cl. 358/498

(57) ABSTRACT

A sheet-fed scanning device including a first scanning channel and a second scanning channel disposed in parallel, a first sensing element and a second sensing element is provided. The first sensing element corresponds to the first scanning channel for acquiring the image of a first type object. The first type object has a first surface which is adjacent to the first sensing element and within the range of the field depth of the first sensing element. The second sensing element corresponds to the second scanning channel for acquiring the image of a second type object. The second type object has a second surface adjacent to the second sensing element and a third surface dented to the second surface, wherein the third surface is within the range of the field depth of the second sensing element.

This application claims the benefit of People's Republic of China application Serial No. 201010220628.4, filed Jun. 24, 2010, the subject matter of which is incorporated herein by reference.

### BACKGROUND OF THE INVENTION

1. Field of the Invention

The invention relates in general to a scanning device, and more particularly to a sheet-fed scanning device.

2. Description of the Related Art

The scanner has become an indispensable electronic product to people in both their work and daily lives. The scanner is an important input/output device for computers. Firstly, a document is scanned with a light provided by a light module. Next, an image signal of the document is obtained by a sensing element. Then, the image signal is converted into a digital signal through photovoltaic conversion to form an image file with digital format. In general, the objects to be scanned can be divided into two types, namely, the reflective document and the transmissive document. Examples of commonly seen reflective documents are such as paper documents, and examples of commonly seen transmissive document are such as camera films.

Currently, there are two types of sensing elements used in the scanner, namely, the contact image sensor (CIS) and the charge-coupled device (CCD). The CIS, having a compact structure, is conformed to the slimness trend of electronic devices, and thus has a wider range of application. However, the CIS has a smaller field depth, which is normally smaller than 0.5 mm, therefore greater difficulty is involved in product design.

Referring to FIG. 1 and FIG. 2. FIG. 1 shows a cross-sectional view of a sheet-fed scanning device 10 scanning a paper document 121 according to the prior art. The driving rod 17 transmits the paper document 121 to pass through the underneath of the CIS component 13. The light source of the CIS component 13 projects a light onto the surface of the paper document 121. The image of the paper document 121 passes through the acquisition window 133, and then is focused and imaged by the rod lens 132. To make the paper document 121 imaged with higher clarity, the field depth of the CIS element 13 must be within 0˜0.5 mm to the acquisition window surface. FIG. 2 shows a cross-sectional view of a sheet-fed scanning device 10 scanning a camera film 122 of a holder 15 according to the prior art. The driving rod transmits the holder 15 to pass through the underneath of the CIS component 13. The light source 14 projects a light onto the lower surface of the camera film 122. The image of the camera film 122 passes through the acquisition window 133, and then is focused and imaged by the rod lens 132. Due to the thickness of the holder 15, the camera film 122 is normally more than 0.5 mm away from the surface of the acquisition window 133. Since such distance is outside the range of the field depth, the image is blurred. To resolve such disadvantage, the CIS element 13 is designed to have an adjustable field depth or have a rod lens 132 which can be moved in a vertical direction so as to provide rooms of adjustment. For ordinary users, the device becomes more complicated and less friendly.

### SUMMARY OF THE INVENTION

The invention is directed to a sheet-fed scanning device including a first scanning channel, a second scanning channel, a first sensing element and a second sensing element is provided. The first scanning channel and the second scanning channel are disposed in parallel. The first sensing element corresponds to the first scanning channel for acquiring the image of a first type object. The first type object has a first surface which is adjacent to the first sensing element and within the range of the field depth of the first sensing element. The second sensing element corresponds to the second scanning channel for acquiring the image of a second type object. The second type object has a second surface which is adjacent to the second sensing element and a third surface which is dented to the second surface and within the range of the field depth of the second sensing element.

As an alternative technical solution, the scanning device of the invention further includes a feeding element. The feeding element includes a first passive roller, a second passive roller, and a driving rod. The driving rod extended from the first channel to the second channel. The first passive roller corresponds to the first scanning channel. The second passive roller corresponds to the second scanning channel. The driving rod and the first passive roller work together to drive the first type object to pass through the first channel. The driving rod and the second passive roller work together to drive the second type object to pass through the second channel.

As an alternative technical solution, the feeding element has a motor for driving the driving rod to rotate.

As an alternative technical solution, the first type object is a reflective document.

As an alternative technical solution, the second type object is a holder holding a transmissive document.

As an alternative technical solution, the distance between the second surface and the third surface ranges between 1.5˜2.6 mm, and the distance between the second surface and the third surface ranges between 2.0˜2.3 mm.

As an alternative technical solution, the first sensing element and the second sensing element are both realized by a contact image sensor (CIS).

As an alternative technical solution, the scanning device includes a number of driving rods and a number of first passive rollers disposed in parallel along the first scanning channel.

As an alternative technical solution, the scanning device includes a number of driving rods and a number of second passive rollers disposed in parallel along the second scanning channel.

As an alternative technical solution, the first sensing element has a first rod lens, the second sensing element has a second rod lens, and the distance between the first rod lens and the first surface is larger than the distance between the second rod lens and the second surface.

Compared with the prior art, the scanning device of the invention has a simple structure, is easy to operate and can acquire clear images of different types of objects.

The above and other aspects of the invention will become better understood with regard to the following detailed description of the exemplary but non-limiting embodiment(s). The following description is made with reference to the accompanying drawings.

### BRIEF DESCRIPTION OF THE DRAWINGS

FIG. 1 shows a cross-sectional view of a sheet-fed scanning device 10 scanning a paper document 121 according to the prior art;

FIG. 2 shows a cross-sectional view of a sheet-fed scanning device 10 scanning a camera film 122 of a holder 15 according to the prior art;

FIG. 3 shows a 3D view of a sheet-fed scanning device according to an embodiment of the invention;

FIG. 4 shows a decomposition diagram of a de-cased scanning device of FIG. 3;

FIG. 5 shows a cross-sectional view along a first scanning channel of FIG. 4;

FIG. 6 shows a cross-sectional view along a second scanning channel of FIG. 4; and

FIG. 7 shows another state diagram of a scanning device of FIG. 3.

### DETAILED DESCRIPTION OF THE INVENTION

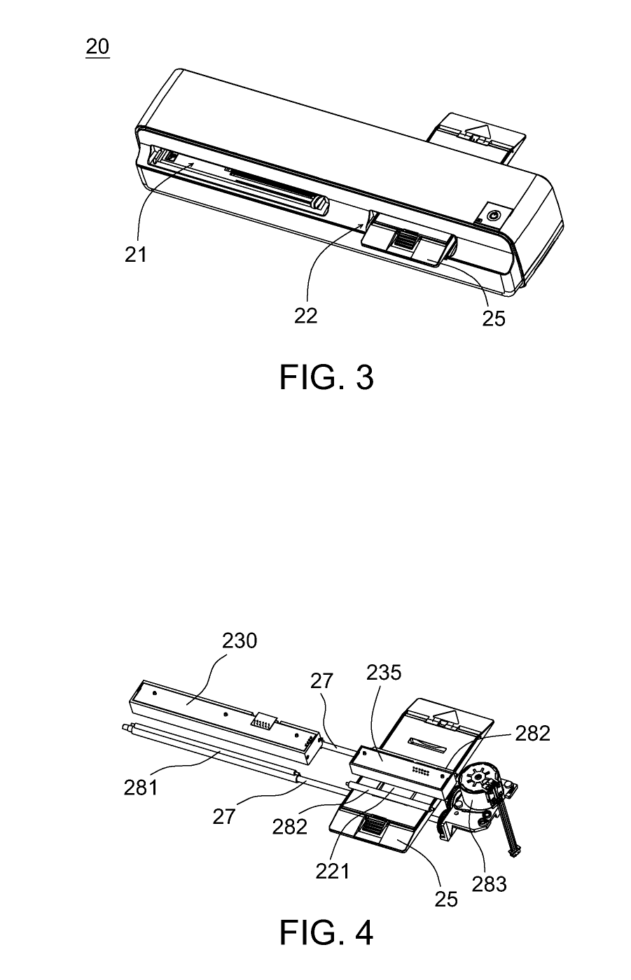

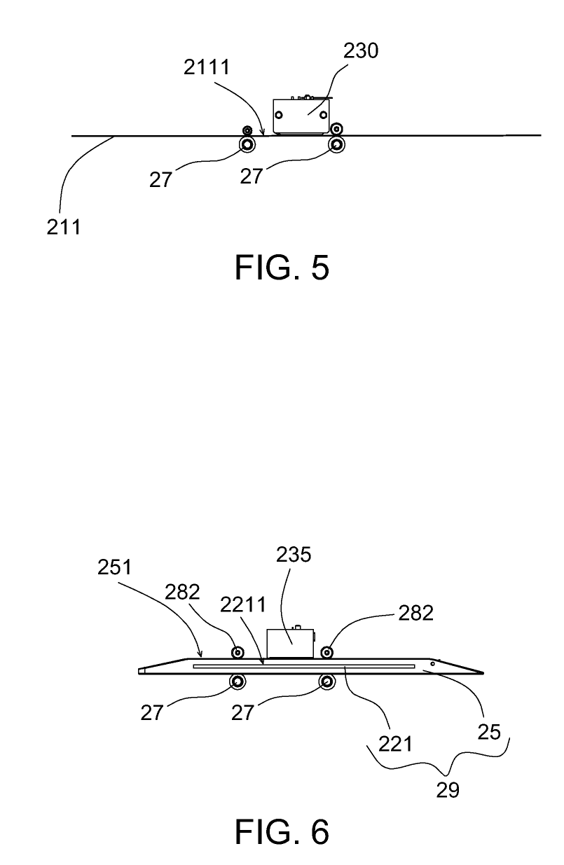

Referring to FIG. 3 and FIG. 4. FIG. 3 shows a 3D view of a sheet-fed scanning device according to an embodiment of the invention. FIG. 4 shows a decomposition diagram of a de-cased scanning device of FIG. 3. The sheet-fed scanning device 20 of an embodiment of the invention includes a first scanning channel 21 and a second scanning channel 22 disposed in parallel. Referring to both FIG. 5 and FIG. 6. FIG. 5 shows a cross-sectional view along a first scanning channel of FIG. 4. FIG. 6 shows a cross-sectional view along a second scanning channel of FIG. 4. As indicated in FIG. 5, the first type object is a reflective document 211, and the second type object 29 is a holder 25 holding a transmissive document 221. The scanning device 20 of the invention further includes a first sensing element 230 corresponding to the first scanning channel 21 for acquiring the image of the reflective document 211. The reflective document 211 has a first surface 2111 which is adjacent to the first sensing element 230 and within the range of the field depth of the first sensing element 2111, so that the first sensing element 230 can acquire a clear image of the reflective document 211. The scanning device 20 further includes a second sensing element 235 corresponding to the second scanning channel 22 for acquiring the image of a second type object 29. The holder 25 of the second type object 29 has a second surface 251 adjacent to the second sensing element 235. The transmissive document 221 has a third surface 2211 which is dented to the second surface 251 and within the range of the field depth of the second sensing element 235, so that the second sensing element 235 can acquire a clear image of the transmissive document 221.

The feeding element 20 of the present embodiment of the scanning device of the invention includes a driving rod 27, a first passive roller 281, and a second passive roller 282. The driving rod 27 is extended from the first channel 21 to the second channel 22. The first passive roller 281 corresponds to the first scanning channel 21. The second passive roller 282 corresponds to the second scanning channel 22. The driving rod 27 and the first passive roller 281 work together to drive the first type object to pass through the first channel 21. The driving rod 27 and the second passive roller 282 work together to drive the second type object to pass through the second channel 22.

In the present embodiment, the feeding element has a motor 283 for driving the driving rods 27 to rotate.

In an exemplary embodiment, the distance between the second surface and the third surface ranges between 1.5˜2.6 mm. In a particular exemplary embodiment, the distance between the second surface and the third surface ranges between 2.0˜2.3 mm. It is to be understood that the distance between the second surface and the third surface is determined according to the thickness of the upper casing of the holder 25. As the thickness of the upper casing of the holder varies with its materials, the distance between the second surface and the third surface will also vary accordingly. The exemplary distance adopted in the present embodiment is based on the thickness commonly used in the upper casing of the holder.

In the present embodiment, the first sensing element 230 and the second sensing element 235 both are realized by a contact image sensor (CIS).

In the present embodiment, the scanning device 20 includes two driving rods 27 and two first passive rollers 281 disposed in parallel along the first scanning channel. The scanning device 20 further includes two second passive rollers 282 disposed in parallel along the second scanning channel. In other embodiments, the quantities of driving rods and passive rollers can be adjusted according to the length of the scanning channels.

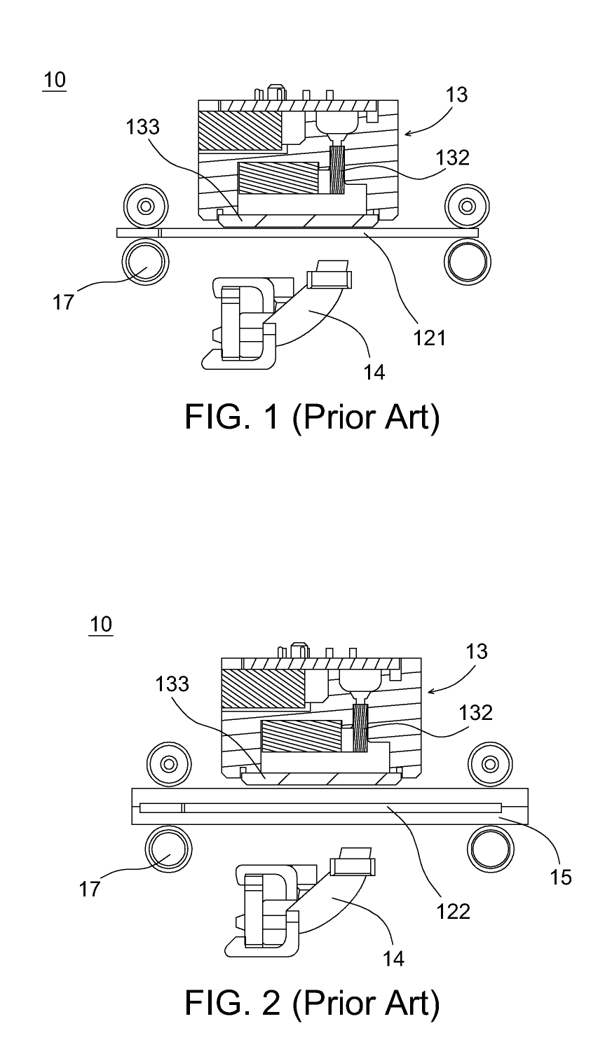

Referring to the elements structure of the CIS of FIG. 1. In the present embodiment, the first sensing element 230 has a first rod lens. The second sensing element 235 has a second rod lens whose focal length is the same with that of the first rod lens. The distance between the first rod lens and the first surface is larger than the distance between the second rod lens and the second surface, so that the field depth of the second sensing element can reach the third surface. In other embodiment, the rod lens adopted in the first sensing element and the second sensing element can have different focal lengths and the same effect still can be achieved.

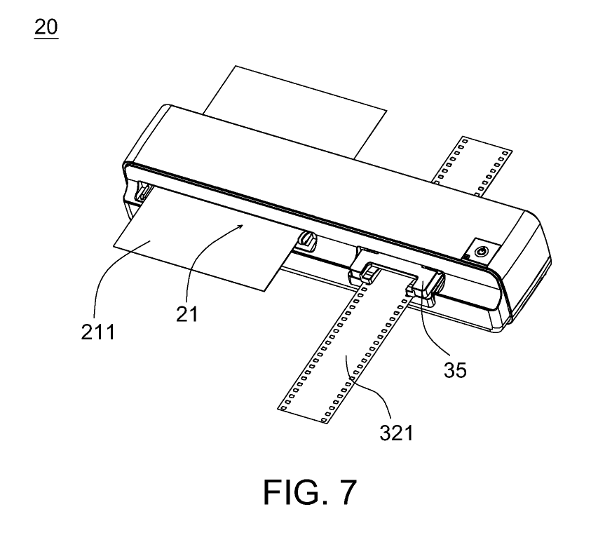

FIG. 7 shows another state diagram of a scanning device of FIG. 3. In FIG. 7, the second type object is a holder 35 and a film 321 held by the holder 35. The holder 35 is inserted in the second scanning channel but does not move. The film 321 is driven by the driving rods 27 and the second passive rollers 282 to pass through the second scanning channel 22 by sliding in the holder 35. The holder 35 has an opening corresponding to the second sensing element 235, and the film 321 is exposed from the opening for scanning.

While the invention has been described by way of example and in terms of the exemplary embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A sheet-fed scanning device, comprising:
a first scanning channel and a second scanning channel disposed in parallel;
a first sensing element corresponding to the first scanning channel for acquiring an image of a first type object, wherein the first type object has a first surface which is adjacent to the first sensing element and within the range of a field depth of the first sensing element;
a second sensing element corresponding to the second scanning channel for acquiring an image of a second type object, wherein the second type object has a second surface which is adjacent to the second sensing element and a third surface which is dented to the second surface and within the range of a field depth of the second sensing element.

2. The scanning device according to claim 1, further comprising a feeding element, the feeding element comprises a driving rod extended from the first channel to the second channel, a first passive roller corresponding to the first scanning channel, and a second passive roller corresponding to the second scanning channel, wherein the driving rod and the first passive roller work together to drive the first type object to pass through the first channel, and the driving rod and the second passive roller work together to drive the second type object to pass through the second channel

3. The scanning device according to claim 1, wherein the feeding element has a motor for driving the driving rods to rotate.

4. The scanning device according to claim 1, wherein the first type object is a reflective document.

5. The scanning device according to claim 1, wherein the second type object is a holder holding a transmissive document.

6. The scanning device according to claim 1, wherein the distance between the second surface and the third surface ranges between 1.5˜2.6 mm.

7. The scanning device according to claim 1, wherein the first sensing element and the second sensing element both are realized by a contact image sensor (CIS).

8. The scanning device according to claim 1, comprising a plurality of driving rods and a plurality of first passive rollers disposed in parallel along the first scanning channel.

9. The scanning device according to claim 1, comprising a plurality of driving rods and a plurality of second passive rollers disposed in parallel along the second scanning channel.

10. The scanning device according to claim 1, wherein the first sensing element has a first rod lens, the second sensing element has a second rod lens, and a distance between the first rod lens and the first surface is larger than a distance between the second rod lens and the second surface.
